(19) United States
(12) Patent Application Publication
(10) Pub. No.: US 2007/0147363 A1
(43) Pub. Date: Jun. 28, 2007

(54) Network edge device configured for adding protocol service header identifying service encoding of IP packet payload

(76) Inventors: Anand K. Oswal, Sunnyvale, CA (US); Guosheng Sun, San Jose, CA (US); Jayaraman R. Iyer, Sunnyvale, CA (US)

Correspondence Address: LEON R TURKEVICH, 2000 M STREET NW, 7TH FLOOR, WASHINGTON, DC, 200363307, US

(21) Appl. No.: 11/315,350

(22) Filed: Dec. 23, 2005

(51) Int. Cl. H04L 12/56

(52) U.S. Cl. 370/389

(57) ABSTRACT

A service header is generated by an edge device (e.g., a gateway or a router) configured for providing a prescribed service operation for a prescribed network service for a received IP packet. The received IP packet includes an IP payload and an IP header having a protocol field specifying an original protocol of the IP payload. The edge device generates an encapsulated payload from the IP payload according to the prescribed network service, and generates a service header that identifies the prescribed network service and the original protocol of the IP payload. The edge device creates a modified IP header from the IP header and that identifies the service header in the corresponding protocol field, and outputs a modified IP packet including the modified IP header, the service header, and the encapsulated payload.

### BACKGROUND OF THE INVENTION

1. Field of the Invention

The present invention relates to providing enhanced services over Internet Protocol (IP) networks based on encapsulation of IP packets with additional information based on the enhanced services.

2. Description of the Related Art

Efforts are underway to improve End-to-End Quality of Service in IP networks (including the ability to add new services with predictable and/or guaranteed quality), where user endpoints can enjoy a guaranteed quality of service for a variety of applications. Difficulties arise, however, in implementing End-to-End Quality of Service implementations due to the difficulty in conveying the application-oriented service requirements to a network device such as a router. Transfer of application-oriented service messages from a customer premises edge device to a network edge device is inefficient because it increases the processing requirements of both the customer premises edge device and the network device. In addition, imposing additional constraints on a network router to support quality of service requirements, such as parsing the packet payload to determine application layer service requirements, would substantially burden the processing capacity of the router.

Encapsulation techniques are known to transfer packets of one network layer protocol across another network layer protocol. For example, Generic Routing Encapsulation (GRE) as described in the Internet Engineering Task Force (IETF) Request for Comments (RFC) 1701 and RFC 2784, provides a standard method for transporting one arbitrary network layer protocol over another arbitrary network layer protocol. In addition, RFC 1702, entitled “Generic Routing Encapsulation over IPv4 Networks”, provides a standard method for transporting an arbitrary network layer protocol over IPv4 using GRE, where the GRE creates a tunnel between two endpoints for transfer of the arbitrary network layer protocol.

In particular, GRE is a tunneling protocol designed for encapsulation of arbitrary kinds of network layer packets inside arbitrary kinds of network layer packets: the original packet serves as the payload for the final packet. For example, tunnel servers which perform encryption can use GRE to tunnel through a wide area network such as the Internet for secure virtual private networks. However, GRE headers only address the problem of hiding IP routing by using tunnels; further, encapsulation techniques such as GRE operate by adding an additional IP routing header to an existing IP packet.

### SUMMARY OF THE INVENTION

There is a need for an arrangement that enables enhanced end-to-end services to be implemented between endpoints by a router, without the necessity of adding additional IP headers.

There also is a need for an arrangement that enables service identification and encoding to be implemented by a router in an efficient manner, without the necessity of adding additional IP headers to an existing IP packet or requiring a router to parse within a payload of a layer 3 packet (e.g., TCP, UDP, etc.)

These and other needs are attained by the present invention, where a service header is generated by a network edge device (e.g., a gateway or an edge router) configured for providing a prescribed service operation for a prescribed network service for a received IP packet. The received IP packet includes an IP payload and an IP header having a protocol field specifying an original protocol of the IP payload. The edge device generates an encapsulated payload from the IP payload according to the prescribed network service, and generates a service header that identifies the prescribed network service and the original protocol of the IP payload. The edge device creates a modified IP header from the IP header and that identifies the service header in the corresponding protocol field, and outputs a modified IP packet including the modified IP header, the service header, and the encapsulated payload.

Hence, the modified packet enables new network-based services to be added easily, and enables routers along a path from a source to a destination to provide the appropriate service-based operations to guarantee any required quality of service. In particular, the modified IP packet enables any router, configured for providing the quality of service operation, to identify the prescribed network service identified in the service header based on identification of the service header from the protocol field of the modified IP header. Hence, the quality of service operation can be provided by any router, without the necessity of parsing within the payload of the original protocol packet. In addition, an edge router can reconstruct the originally-received IP packet from the encapsulated payload for delivery to a user device.

One aspect of the present invention provides a method in a network edge device. The method comprises receiving by the network edge device a received Internet Protocol (IP) packet that includes an IP payload and an IP header having a protocol field specifying an original protocol of the IP payload. The method also includes generating by the network edge device a modified IP packet for a prescribed network service based on a prescribed detected condition. The modified IP packet is generated based on: (1) first generating an encapsulated payload from the IP payload according to the prescribed network service, (2) second generating a service header that identifies the prescribed network service and the original protocol of the IP payload, and (3) modifying the IP header of the received IP packet by changing the corresponding protocol field in the IP header to identify the service header. The method also includes outputting the modified IP packet, including the modified IP header and a modified IP payload including the service header and the encapsulated payload, to a next-hop router for transfer to a destination according to the prescribed network service.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed out in the appended claims.

### BRIEF DESCRIPTION OF THE DRAWINGS

Reference is made to the attached drawings, wherein elements having the same reference numeral designations represent like elements throughout and wherein:

FIG. 1 is a diagram illustrating a network configured for providing customized network services, according to an embodiment of the present invention.

FIG. 2 is a diagram illustrating modification of a received IP packet into a modified packet, including a service header specifying the network service applied to the original IP packet, according to an embodiment of the present invention.

FIG. 3 is a diagram illustrating in detail a modification of the protocol field of the original IP header of FIG. 2.

FIG. 4 is a diagram illustrating in further detail the service header of FIG. 2.

FIG. 5 is a diagram illustrating the method by each of the edge routers of FIG. 1 of processing a received packet based on identifying a prescribed network service for the packet, according to an embodiment of the present invention.

### BEST MODE FOR CARRYING OUT THE INVENTION

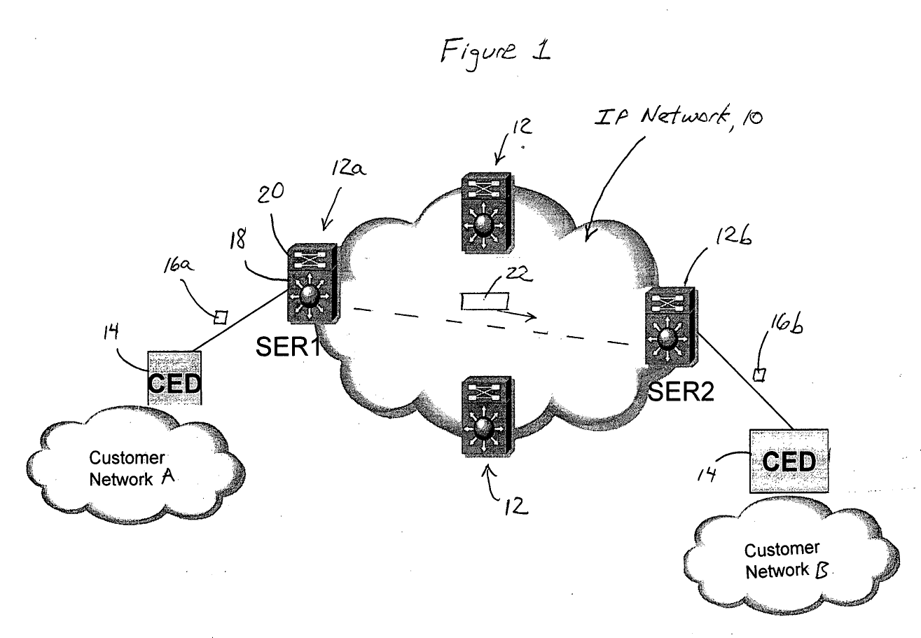

FIG. 1 is a diagram illustrating a network 10 configured for providing enhanced end-to-end quality of service for customized network applications, and enabling the addition of new network-based services, according to an embodiment of the present invention. The network 10 includes edge devices (e.g., gateways, routers, etc.) 12, also referred to as service encoding routers or service edge routers (SER), configured for interfacing with customer premises devices 14. The IP network 10 also includes additional internal routers (not shown), which optionally may include the ability to support the enhanced network services described herein. Each edge device 12a and 12b is configured for serving as an ingress node and/or egress node to/from the IP network 10 with respect to customer premises devices 14, or other external wide area networks (not shown). The description of the edge devices 12a and 12b assume for example that they are implemented as edge routers.

Each of the customer premises devices 14 is configured for outputting and receiving conventional IP packets (e.g., 16a, 16b) to and from a corresponding assigned edge router 12; for example, the customer premises device 14 of the customer network A, implemented as a customer edge device (CED) such as a router, is configured for outputting the IP packet 16a to the service encoding router 12a, and the customer premises device 14 of the customer network B is configured for receiving the IP packet 16b from the service encoding router 12b. From the perspective of the customer premises devices 14 of customer networks A and B, the IP packets 16a and 16b are the same packet, where the packet 16b represents traversal of the packet 16a across the IP network 10.

According to the disclosed embodiment, the IP network 10 is configured for supporting enhanced end-to-end quality of service requirements for customized network applications, including secure encryption of data packets, compression of voice packets for transfer across the network 10 (e.g., an IP based cellular backhaul network), or support for Enterprise Resource Planning (ERP) applications, etc. Each IP edge router 12 (e.g., 12a) includes a network interface 18 configured for receiving the IP packet 16a from a source customer edge device 14 (and transmitting a recovered IP packet 16b to a destination customer edge device 14), and a routing resource 20 configured for performing conventional routing operations, as well as service identification and encoding. As described below, each IP edge router 12 is configured for supporting numerous network-based application services within the IP network 10 without relying on any support from the customer edge devices 14, based on the corresponding routing resource 20 performing service identification and encoding of received IP packets 16a prior to transport via the IP network 10 as a modified packet 22. The service identification, implemented in the form of a service header added by the routing resource 20 of the ingress IP edge router 12a (SER1), enables each service-aware router in the IP network 10 to route the packet according to the quality of service requirements and policies required by the application service specified by the service header, and enables the routing resource 20 of the egress router 12b (SER2) to recover the original IP packet 16b for delivery to the destination customer edge device 14 of the customer network B.

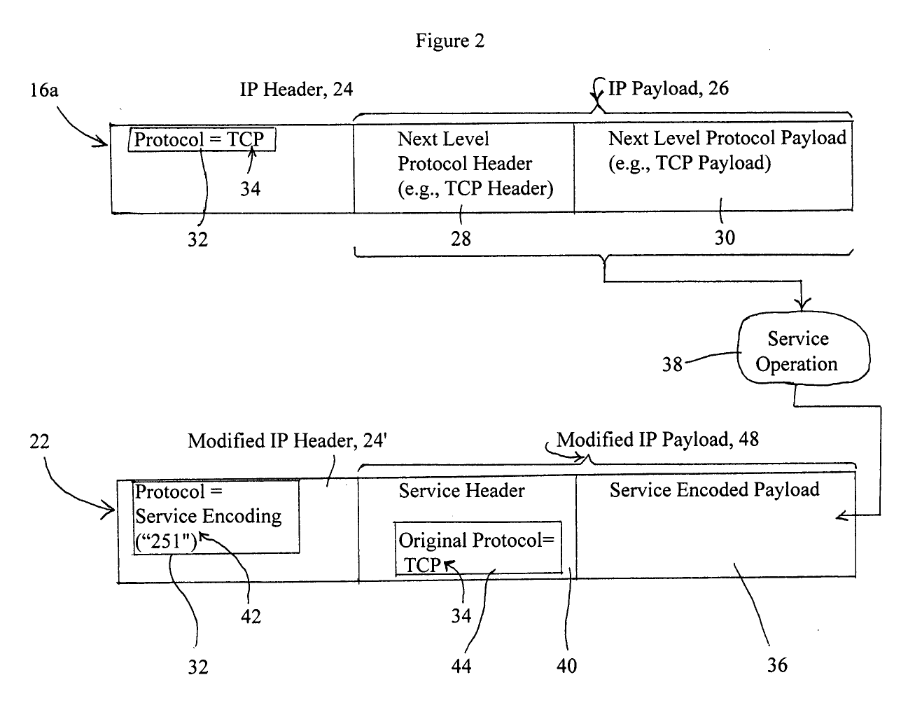

FIG. 2 is a diagram illustrating modification by the routing resource 20 of the original IP packet 16a into the modified IP packet 22, for providing enhanced transport according to a prescribed network service, according to an embodiment of the present invention. As known in the art, a conventional IP packet 16a includes an IP header 24 and an IP payload 26. The IP payload 26 typically includes the next higher level packet, for example a TCP packet or UDP packet, including a next level protocol header (e.g., TCP header) 28 and the next level protocol payload (e.g., TCP payload) 30. The IP header 24 includes a protocol field 32 that specifies the original protocol (e.g., TCP) 34 of the IP payload 26.

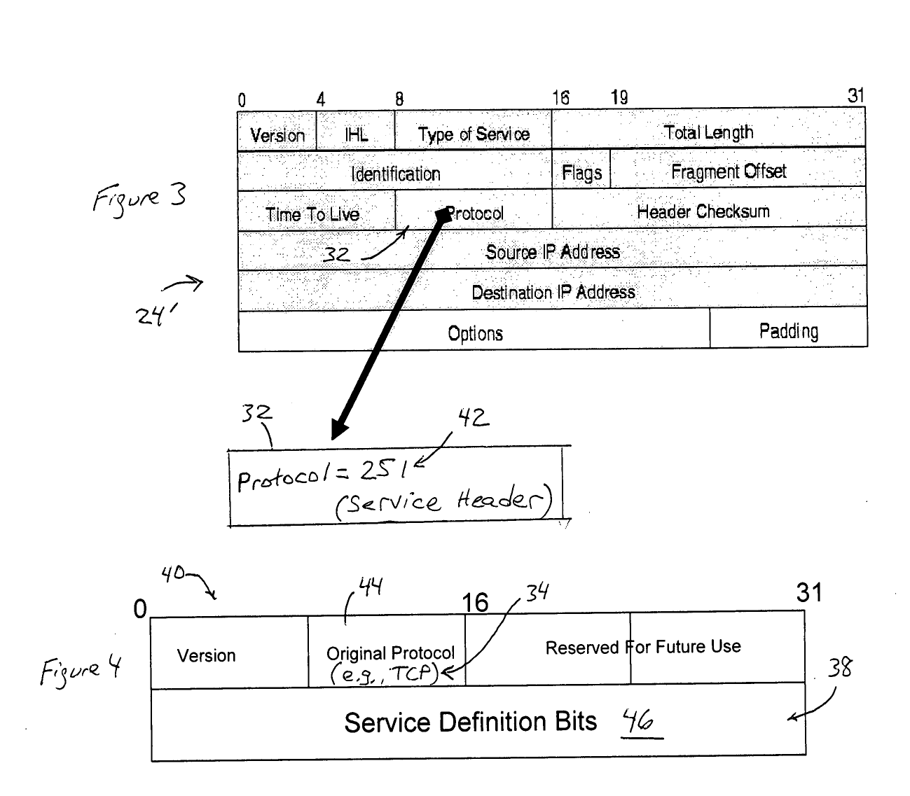

As described in detail below with respect to FIGS. 3, 4 and 5, the routing resource 20 of the ingress edge router 12a is configured for generating a modified IP packet 22 that includes a modified IP payload 48. The modified IP payload 48 is generated based on generating a service encoded payload 36 according to a prescribed network service operation 38, and inserting a service header 40 that identifies the prescribed network service 38 and the original protocol 34. The routing resource 20 also updates the protocol field 32 of the IP header 24 with an identifier 42 (e.g., “251”) that uniquely identifies the service header 14, enabling any service-aware router 12 to identify the service operation 38 based on parsing the service header 40.

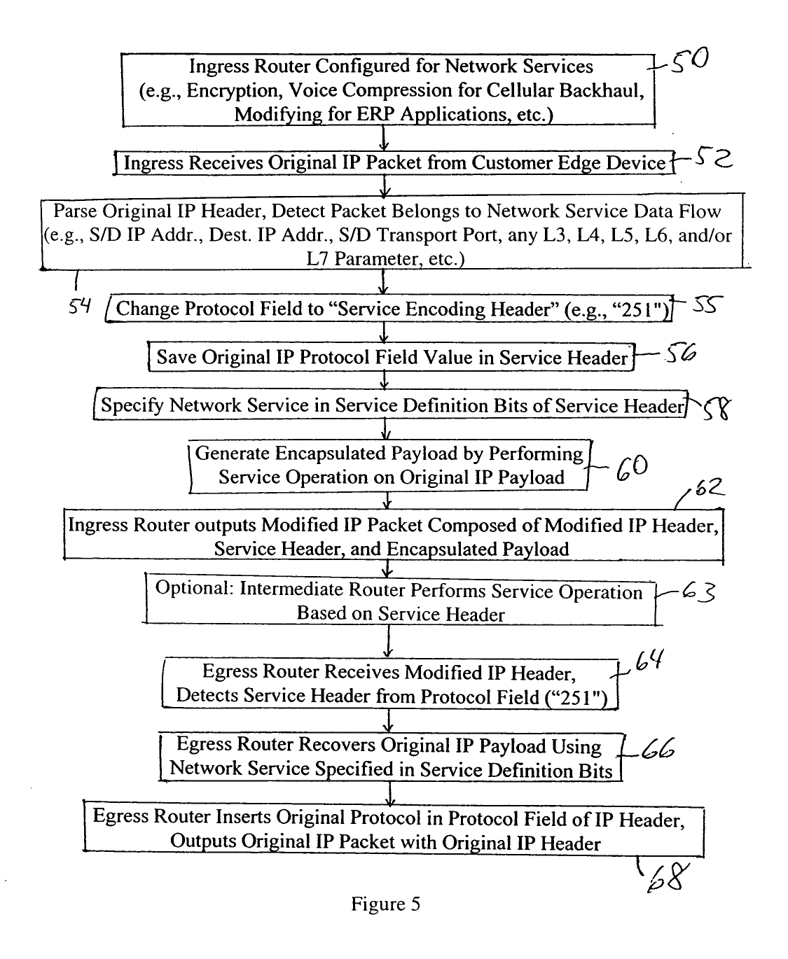

FIG. 5 is a diagram illustrating the method by the edge routers 12 (e.g., 12a and 12b) of providing enhanced network services based on encoding a received packet 16a into an encoded packet 22, and decoding the encoded packet 22 into a recovered packet 16b, according to an embodiment of the present invention. The steps described in FIG. 5 can be implemented as executable code stored on a computer readable medium (e.g., a hard disk drive, a floppy drive, a random access memory, a read only memory, an EPROM, a compact disk, etc.), or propagated via a computer readable medium (e.g., a transmission wire, an optical fiber, a wireless transmission medium utilizing an electromagnetic carrier wave, etc.).

The method begins in step 50, where the routing resource 20 of each edge router (e.g., 12a and 12a) is configured for providing the desired network services, for example encryption, voice compression, modifying packets for ERP applications, etc., based on configuring or adding the appropriate executable resource within the routing resource 20, for example defining services based on extensible markup language (XML) descriptors, software or firmware updates, etc.

After each routing resource 20 has been appropriately configured, the network 10 is prepared to provide the enhanced network services. In particular, the ingress edge router 12a receives in step 52 the original IP packet 16a from the customer edge device 14 of the customer network A. In response to parsing in step 54 the IP header 24, the routing resource 20 identifies a next-hop path for the packet, and also determines that the IP packet 16a belongs to a data flow for a prescribed network service. The routing resource 20 may identify the network service data flow, for example, based on evaluating layer 3 (i.e., Network Layer) parameters including any one of a source-destination IP address pair, the destination IP address, and/or evaluating layer 4 (i.e., Transport Layer) parameters within the next level protocol header 28, for example TCP/UDP source and/or destination transport port, etc. The routing resource 20 also may identify the network service data flow, for example, based on detecting and evaluating prescribed parameters within the next level protocol payload 30, including any one of the layer 5 (Session Layer), layer 6 (Presentation), or layer 7 (Application Layer) parameters.

In response to determining that the received IP packet 16a should be encoded into the modified IP packet 22 in order to allow other network devices in the network 10 to apply enhanced application-aware services to the packet, the routing resource 20 modifies the IP header 24 into the modified IP header 24′, inserts the service header 40, and performs the prescribed service operation 38 on the IP payload 26 to generate the service encoded payload 36. In particular, the routing resource 20 changes in step 55 the protocol field 32 in the IP header 24, as illustrated in FIG. 3, to a prescribed identifier (e.g., “251”) 42 that uniquely identifies the “next protocol” as a service encoding header 40. As apparent from the foregoing, it is assumed that the prescribed identifier (e.g., “251”) 42 is universally recognized by all service-aware routers 12 in the IP network 10; although the prescribed identifier could be set privately for private networks, it is preferred that the prescribed identifier 40 to be assigned by the IETF, for example by updating RFC 1700 to specify that the prescribed identifier 42 identifies the service encoding header 40.

The routing resource 20 also saves the original IP protocol field value 34 in the service header 40 by inserting in step 56 the original IP protocol field value 34 in an original protocol field 44, illustrated in FIG. 4. The routing resource 20 also specifies the network service operation 38, or generally the network service being applied, in a service definition field 46 of the service header 40 in step 58. The routing resource 20 generates the encapsulated payload 36 of FIG. 2 by performing the prescribed network service operation 38 on the original IP payload 26 in step 60. As described previously, the network service operation 38 may involve any one of a number of operations depending on the application service, for example voice compression for cellular backhaul, encryption for secure communications, or modifying the packet for ERP applications, including adding an attribute information that identifies the source of the packet 22, time of receipt by the packet, etc.

After the routing resource 20 of the ingress edge router 12a has generated the modified packet 22 including the modified IP header 24′, and the modified IP payload 48 including the service header 40 and the service encoded payload 36, the IP interface 18 of the ingress edge router 12a outputs in step 62 the modified IP packet 22 to a next-hop router in the IP network 10 for transfer to a destination (customer network B) according to the prescribed network service 38. As described previously, numerous internal routers in the IP network 10, including the next-hop router, may or may not have the service-aware capabilities to interpret the service header 40, depending on the needs of the application service; for example, if encryption or compression is the application service being applied, then no other internal router of the IP network 10 needs to process the service header 40; however, if the applied application service is for a guaranteed latency or bandwidth (e.g., for video streaming, etc.), then each next-hop router (or at least one intermediate router) may be configured to route the packet in step 63 according to the prescribed network service 38 specified in the service definition field 46 (e.g., providing preferential or special treatment for a guaranteed quality of service, rerouting the packet based on the prescribed network service 38, etc.).

The egress router 12b is positioned at the destination edge of the network 10, and provides connectivity to the network 10 for the customer edge device 14 of the destination customer network B. The network interface 18 of the egress router 12b receives the modified IP packet 22 in step 64, and the routing resource 20 of the egress router 12b detects from the protocol field 32 the service header identifier 42 specifying that the next header in the modified IP payload 48 is the service header 40. In response to detecting the service header 40 from the protocol field 32 of the IP header 24′, the routing resource 20 in the egress router 12b determines the prescribed network service operation from the identifier 38 that is specified in the service definition field 46 of the service header 40. The routing resource 20 in the egress router 12b recovers in step 66 the original IP payload 26 from the service encoded payload 36 using the network service 38 specified in the service definition field 46. The routing resource 20 of the egress router 12b then inserts in step 68 the original protocol value 34 into the protocol field 32 of the IP header 24, and outputs the recovered packet 16b, identical to the original transmitted packet 16a.

According to the disclosed embodiment, enhanced network-based application services are provided within the network 10 without the necessity of adding an additional IP header; rather, a service header 34 that identifies an application layer service is added at the layer 3 level (based on updating the protocol field 32), enabling service identification to be identified with minimal additional overhead in the IP packet.

While the disclosed embodiment has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method in a network edge device, the method comprising:
receiving by the network edge device a received Internet Protocol (IP) packet that includes an IP payload and an IP header having a protocol field specifying an original protocol of the IP payload;
generating by the network edge device a modified IP packet for a prescribed network service based on a prescribed detected condition, based on:
(1) first generating an encapsulated payload from the IP payload according to the prescribed network service,
(2) second generating a service header that identifies the prescribed network service and the original protocol of the IP payload, and
(3) modifying the IP header of the received IP packet by changing the corresponding protocol field in the IP header to identify the service header; and
outputting the modified IP packet, including the modified IP header and a modified IP payload including the service header and the encapsulated payload, to a next-hop router for transfer to a destination according to the prescribed network service.

2. The method of claim 1, wherein the generating includes generating the IP modified packet to include the modified IP header, the service header, and the encapsulated payload, without any other IP header in the modified IP packet.

3. The method of claim 1, wherein the receiving includes receiving the received IP packet via a connection with a customer premises device.

4. The method of claim 1, further comprising detecting the prescribed detected condition based on identifying the received IP packet as belonging to a prescribed data flow based on parsing at least one of the IP header, and information according to the original protocol in the IP payload, including any one of layer 4, layer 5, layer 6, and layer 7 parameters.

5. The method of claim 1, wherein the first generating includes encoding the IP payload according to the prescribed network service for transport via a content network that includes the network edge device and the next-hop router.

6. The method of claim 5, wherein the prescribed network service specifies encoding the IP payload by any one of encryption, compression, and modification according to a corresponding distributed network application.

7. The method of claim 1, further comprising:
receiving from the next-hop router a second IP packet including a corresponding second IP header and a second encapsulated payload;
generating a recovered IP packet from the second IP packet according to a second prescribed network service, based on:
(1) detecting the corresponding service header in the second IP packet based on the corresponding protocol field in the IP header identifying the service header, the protocol field of the modified IP header and the second IP header specifying a same prescribed value for identification of the corresponding service header,
(2) determining, from the service header, an identifier for the second prescribed network service and a second identifier for a corresponding second original protocol for the IP payload,
(3) recovering a second original IP payload, according to the second original protocol, from the second encapsulated payload based on applying a decapsulation operation according to the second prescribed network service, and
(4) generating a recovered IP header based on specifying the second original protocol in the corresponding protocol field of the second IP header; and
outputting the recovered IP packet, including the recovered IP header and the second original IP payload, for delivery to an identified destination specified in a destination address field of the recovered IP header.

8. A network configured for providing prescribed network services for received Internet Protocol (IP) packets, the network comprising:
a first network edge device at a first edge of the network and configured for receiving a received Internet Protocol (IP) packet that includes an IP payload and an IP header having a protocol field specifying an original protocol of the IP payload, the first network edge device configured for outputting a modified IP packet for a prescribed network service based on a prescribed detected condition, the modified IP packet including:
(1) an encapsulated payload generated from the IP payload according to the prescribed network service,
(2) a service header that identifies the prescribed network service and the original protocol of the IP payload, and
(3) a modified IP header created from modifying the IP header of the received IP packet by changing the corresponding protocol field in the IP header to identify the service header; and
a second network edge device at a second edge of the network and configured for recovering the received IP packet from the modified IP packet, according to the prescribed network service, based on: (1) detecting the service header identified in the protocol field of the modified IP header, and (2) detecting the prescribed network service from the service header.

9. The network of claim 8, wherein the first network edge device is configured for generating the IP modified packet to include the modified IP header, the service header, and the encapsulated payload, without any other IP header in the modified IP packet.

10. The network of claim 8, wherein the first network edge device is configured for receiving the received IP packet via a connection with a customer premises device.

11. The network of claim 8, wherein the first network edge device is configured for detecting the prescribed detected condition based on identifying the received IP packet as belonging to a prescribed data flow based on parsing at least one of the IP header, and information according to the original protocol in the IP payload, including any one of layer 4, layer 5, layer 6, and layer 7 parameters.

12. The network of claim 8, wherein the prescribed network service specifies encoding the IP payload by any one of encryption, compression, and modification according to a corresponding distributed network application.

13. The network of claim 8, wherein the second network edge device is configured for recovering the IP payload from the modified IP packet based on having detected the prescribed network service, the second network edge device outputting the received IP packet, based on recovery thereof, for delivery to an identified destination specified in a destination address field of the IP header.

14. The network of claim 8, further comprising an intermediate router configured for routing the modified IP packet, having been output by the first network edge device, toward the second network edge device and according to the prescribed network service in response to detecting the protocol field identifying the service header, and based on determining the prescribed network service from the service header.

15. A computer readable medium having stored thereon sequences of instructions for processing a received IP packet by a network edge device, the sequences of instructions including instructions for:
receiving by the network edge device a received Internet Protocol (IP) packet that includes an IP payload and an IP header having a protocol field specifying an original protocol of the IP payload;
generating by the network edge device a modified IP packet for a prescribed network service based on a prescribed detected condition, based on:
(1) first generating an encapsulated payload from the IP payload according to the prescribed network service,
(2) second generating a service header that identifies the prescribed network service and the original protocol of the IP payload, and
(3) modifying the IP header of the received IP packet by changing the corresponding protocol field in the IP header to identify the service header; and
outputting the modified IP packet, including the modified IP header and a modified IP payload including the service header and the encapsulated payload, to a next-hop router for transfer to a destination according to the prescribed network service.

16. The medium of claim 15, wherein the generating includes generating the IP modified packet to include the modified IP header, the service header, and the encapsulated payload, without any other IP header in the modified IP packet.

17. The medium of claim 15, wherein the receiving includes receiving the received IP packet via a connection with a customer premises device.

18. The medium of claim 15, further comprising instructions for detecting the prescribed detected condition based on identifying the received IP packet as belonging to a prescribed data flow based on parsing at least one of the IP header, and information according to the original protocol in the IP payload, including any one of layer 4, layer 5, layer 6, and layer 7 parameters.

19. The medium of claim 15, wherein the first generating includes encoding the IP payload according to the prescribed network service for transport via a content network that includes the network edge device and the next-hop router.

20. The medium of claim 19, wherein the prescribed network service specifies encoding the IP payload by any one of encryption, compression, and modification according to a corresponding distributed network application.

21. The medium of claim 15, further comprising instructions for:
receiving from the next-hop router a second IP packet including a corresponding second IP header and a second encapsulated payload;
generating a recovered IP packet from the second IP packet according to a second prescribed network service, based on:
(1) detecting the corresponding service header in the second IP packet based on the corresponding protocol field in the IP header identifying the service header, the protocol field of the modified IP header and the second IP header specifying a same prescribed value for identification of the corresponding service header,
(2) determining, from the service header, an identifier for the second prescribed network service and a second identifier for a corresponding second original protocol for the IP payload,
(3) recovering a second original IP payload, according to the second original protocol, from the second encapsulated payload based on applying a decapsulation operation according to the second prescribed network service, and
(4) generating a recovered IP header based on specifying the second original protocol in the corresponding protocol field of the second IP header; and
outputting the recovered IP packet, including the recovered IP header and the second original IP payload, for delivery to an identified destination specified in a destination address field of the recovered IP header.

22. A network edge device comprising:
a network interface configured for receiving a received Internet Protocol (IP) packet that includes an IP payload and an IP header having a protocol field specifying an original protocol of the IP payload; and
a routing resource configured for generating a modified IP packet for a prescribed network service based on a prescribed detected condition, the routing resource configured for:
(1) generating an encapsulated payload from the IP payload according to the prescribed network service,
(2) generating a service header that identifies the prescribed network service and the original protocol of the IP payload, and
(3) modifying the IP header of the received IP packet by changing the corresponding protocol field in the IP header to identify the service header;
the network interface configured for outputting the modified IP packet, including the modified IP header and a modified IP payload including the service header and the encapsulated payload, to a next-hop router for transfer to a destination according to the prescribed network service.

23. The network edge device of claim 22, wherein the routing resource is configured for generating the IP modified packet to include the modified IP header, the service header, and the encapsulated payload, without any other IP header in the modified IP packet.

24. The network edge device of claim 22, wherein the network interface is configured for receiving the received IP packet via a connection with a customer premises device.

25. The network edge device of claim 22, wherein the routing resource is configured for detecting the prescribed detected condition based on identifying the received IP packet as belonging to a prescribed data flow based on parsing at least one of the IP header, and information according to the original protocol in the IP payload, including any one of layer 4, layer 5, layer 6, and layer 7 parameters.

26. The network edge device of claim 22, wherein the routing resource is configured for encoding the IP payload according to the prescribed network service for transport via a content network that includes the network edge device and the next-hop router.

27. The network edge device of claim 26, wherein the prescribed network service specifies encoding the IP payload by any one of encryption, compression, and modification according to a corresponding distributed network application.

28. The network edge device of claim 22, wherein:
the network interface is configured for receiving from the next-hop router a second IP packet including a corresponding second IP header and a second encapsulated payload;
the routing resource configured for generating a recovered IP packet from the second IP packet according to a second prescribed network service, based on:
(1) detecting the corresponding service header in the second IP packet based on the corresponding protocol field in the IP header identifying the service header, the protocol field of the modified IP header and the second IP header specifying a same prescribed value for identification of the corresponding service header,
(2) determining, from the service header, an identifier for the second prescribed network service and a second identifier for a corresponding second original protocol for the IP payload,
(3) recovering a second original IP payload, according to the second original protocol, from the second encapsulated payload based on applying a decapsulation operation according to the second prescribed network service, and
(4) generating a recovered IP header based on specifying the second original protocol in the corresponding protocol field of the second IP header;
the network interface configured for outputting the recovered IP packet, including the recovered IP header and the second original IP payload, for delivery to an identified destination specified in a destination address field of the recovered IP header.

29. A network edge device comprising:
means for receiving a received Internet Protocol (IP) packet that includes an IP payload and an IP header having a protocol field specifying an original protocol of the IP payload; and
means for generating a modified IP packet for a prescribed network service based on a prescribed detected condition, means for generating configured for:
(1) generating an encapsulated payload from the IP payload according to the prescribed network service,
(2) generating a service header that identifies the prescribed network service and the original protocol of the IP payload, and
(3) modifying the IP header of the received IP packet by changing the corresponding protocol field in the IP header to identify the service header;
the means for receiving configured for outputting the modified IP packet, including the modified IP header and a modified IP payload including the service header and the encapsulated payload, to a next-hop router for transfer to a destination according to the prescribed network service.
